(19) United States
(12) Patent Application Publication
(10) Pub. No.: US 2020/0000276 A1
(43) Pub. Date: Jan. 2, 2020

(54) METHOD FOR DIGITIZING A COOKING PROCESS, KITCHEN APPARATUS AND SYSTEM FOR DIGITIZING A COOKING PROCESS

(71) Applicant: Vorwerk & Co. Interholding GmbH, Wuppertal (DE)

(72) Inventors: Uwe KEMKER, Wuppertal (DE); Christian LICHAU, Herne (DE); Sarah WERHAHN, Zürich (CH); Gerhard ISENBERG, Köln (DE); Thomas BÜNING, Bochum (DE); Andreas UHLENBROCK, München (DE); Robert FRIELINGHAUS, Bochum (DE)

(21) Appl. No.: 16/456,845

(22) Filed: Jun. 28, 2019

(30) Foreign Application Priority Data
Jul. 2, 2018 (DE) 10 2018 115 988.9

(51) Int. Cl. A47J 36/32; G06F 16/23; G06F 16/25; A47J 44/00; A47J 43/046; A47J 27/00; A23L 5/10

(52) U.S. Cl. CPC A47J 36/321; G06F 16/2365; G06F 16/252; A47J 44/00; A23V 2002/00; A47J 27/004; A23L 5/15; A47J 2202/00; A47J 43/046

(57) ABSTRACT

The invention concerns a method (100) for the digitalization a cooking process (200) in a kitchen appliance (10) comprising the following steps:
Detection (103) of at least one operating parameter (210) of the kitchen appliance (10) during a manual user interaction (201) for processing an ingredient (2) recorded in the kitchen appliance (10).

The invention also concerns a kitchen appliance (10) for production of a cooking process (200) and a system (1) for the digitalization of a cooking process.

### DESCRIPTION

The invention relates to a method for the digitalization of a cooking process in a kitchen appliance, a kitchen appliance for performing a cooking process according to the preamble of independent claim 12, and a system for digitalizing a cooking process according to the generic term of independent claim 13.

It is known from the state of the art, that electrical kitchen appliances are used for the automatic processing of food according to predefined recipe parameters. In addition to mechanical processing of food, e.g. by means of a stirrer and/or a cutting knife, such electrical kitchen appliances often also allow the ingredients to be cooked. For this purpose, predefined recipes are provided in order to enable a user to achieve a reproducible cooking result in the most convenient way possible. The recipes are often stored in a memory connected to the kitchen appliance and, in addition to the instructions provided to the user, also include target specifications for the kitchen appliance, such as heating the ingredients to a certain temperature.

It is the intention of the suppliers of such electrical kitchen appliances to ensure that the recipes are of high quality and thus enable the user to achieve a positive, reproducible cooking result. It is well known that recipes are created by the providers themselves and given to the user. This ensures that operating parameters for the kitchen appliance are correctly selected and ingredients are carefully selected in a professional environment.

However, many recipes are in the possession of individuals or families and are passed down from generation to generation. It is therefore desirable to enable a user of such a kitchen appliance to produce such recipes on the kitchen appliance, in particular recipes owned by the family, and to integrate them as conveniently as possible into the automatic cooking process and/or to digitalize them for later reproduction of the recipe. Due to the growing number of online communities, it is also of interest that a user can share individually known recipes with a larger number of people.

It is therefore an object of the present invention to at least partially eliminate previous disadvantages known from the state of the art. In particular, one object of the present invention is to simplify the digitalization of cooking processes so that a user of a kitchen appliance can do this in the simplest and most reliable way possible.

The object is solved by a method with the features of independent claim 1, a kitchen appliance with the features of independent claim 12 and a system with the features of independent claim 13. Further features and details of the invention result from the respective dependent claims, the description and the drawings. Features and details which have been described in connection with the method according to the invention naturally also apply in connection with the kitchen appliance according to the invention as well as the system according to the invention and vice versa in each case, so that with regard to the disclosure, mutual reference to the individual aspects of the invention is or can always be made.

According to the invention, the method for the digitalization of a cooking process in a kitchen appliance comprises the following steps:
Detecting at least one operating parameter of the kitchen appliance during a manual user interaction for processing an ingredient recieved in the kitchen appliance,
Identifying the ingredient by interpreting at least the operating parameter and the manual user interaction.

In particular, at least one ingredient is included in the kitchen appliance during the recording of at least one operating parameter of the kitchen appliance. For this purpose, the ingredient can, for example, be stored in a cooking vessel of the kitchen appliance. In particular, the ingredients for the cooking process are received by the kitchen appliance before they are recorded. The kitchen appliance can preferably be a kitchen machine for at least partially automatic processing of recipes. The kitchen appliance may preferably include a sensor device for recording the operating parameter.

The at least one operating parameter can preferably be understood as a measured value, in particular of the sensor device, by means of which a certain property of the ingredient can be inferred. It is conceivable, for example, that at least one operating parameter will include at least one of the following measured variables:
Weight, especially weight distribution,
Energy supply, in particular current and/or voltage,
Temperature, in particular temperature distribution, in the cooking vessel and/or the ingredient,
Visual appearance of the ingredient, in particular colouring.

In particular, manual user interaction capture may be understood as recording the operating parameter during or as a result of manual user interaction and preferably correlating it with manual user interaction. Several operating parameters can preferably be used during interpretation to identify the ingredient. In particular, interpretation may include an assessment and/or estimation of at least one operating parameter and manual user interaction. Preferably interpreting can also be called evaluating. In particular, the at least one operating parameter in combination with the manual user interaction forms a characteristic by which the ingredient can be inferred. For example, it is conceivable that the energy supply to the agitator of the kitchen appliance could be used to measure the resistance of the ingredient to mixing and/or crushing, and that the weight of the ingredient could be used to infer a certain ingredient. Furthermore, it is conceivable that the temperature in connection with the colouring of the ingredient, especially at a certain point in the cooking process, can lead to the identification of the ingredient. Manual user interaction may preferably include the start of a heating operation, the start of a cutting and/or stirring operation and/or the like. In particular, the user interaction may include one or more manual partial interactions and/or one or more manual settings. Manual user interaction can therefore be defined as the triggering of a particular function by the user. The manual user interaction can preferably include a setpoint specification, which can, for example, specify a setpoint temperature, a setpoint ambient speed and/or a direction of rotation of the agitator. Thus, for example, the specification of a certain calorific value in combination with a certain rotational speed of the agitator can be a first indicator for the use of a certain ingredient. Finally, if at least one operating parameter is included, this can already lead to a high degree of reliability in the recognition of ingredients. The identification of the ingredient can also advantageously include assigning the ingredient to a text element. This allows the text element to be displayed in a way that is understandable to the user and/or to be available as a character string. In particular, the identification of the ingredient can thus also be referred to as the recognition of the ingredient, preferably on the basis of known data.

This provides a method for the digitalization of a cooking process, which allows the user in a convenient way an automatic recognition of the ingredients used, especially without the necessity of a manual input of the ingredients for integration into digital recipe data is necessary. On the one hand, this saves the user time when digitalizing the recipe. On the other hand, incorrect input can be avoided so that a high degree of reliability can be guaranteed in the recognition of ingredients or recipe steps.

Preferably, in a method according to the invention, the detection of at least one operating parameter may include recording a course of time of at least one operating parameter. The history of at least one operating parameter may include, for example, a heating curve, a motor current curve and/or a weight distribution during a stirring operation. The course can therefore be a special characteristic of the ingredient, which can be detected accordingly by a sensor device. In particular, manual user interaction can also be represented by the course, in that a target parameter, such as a specified target time of a heating process, can be included in the course or be recognizable from it. The course of time of at least one operating parameter can thus be given a further dimension, which can increase the reliability in the recognition of the ingredient. In addition, the course can be used to reproduce the cooking process in a particularly simple way. It is conceivable that at least one operating parameter, for example a temperature development curve over time, can be simulated by a control loop, so that the ingredient can be reproducibly brought into the corresponding state as a result.

Furthermore, in a method according to the invention, interpreting to identify the ingredient may include pairing at least the operating parameter and/or the manual user interaction with a reference database. The reference database can, for example, be provided on a server or a storage unit of the kitchen appliance. The comparison of at least one operating parameter and the manual user interaction with the reference database shall preferably include a search of identical or similar reference data sets, which may in particular include reference parameters and/or reference interactions, in the reference database. If a sufficient similarity or even identity is found, a certain ingredient can be inferred with a high degree of certainty. The reference database thus contains preferably entries of known ingredients and user interactions. In particular, an interpretation for identifying the ingredient based on previously determined and/or learned data is possible.

In the context of the invention it can be planned that the manual user interaction is assigned to an action sequence of the cooking process, in particular whereby the interpretation for identifying the ingredient is performed on the basis of the action sequence. The action sequence may preferably include a specific sequence of user interactions and/or ingredient additions. Furthermore, the sequence of action may have temporal progressions of at least one operating parameter or different operating parameters. Thus, at least one operating parameter can be assigned to the action sequence. The action sequence therefore preferably represents a section within the cooking process, whereby several action sequences preferably represent the cooking process. For simple recipes, however, a single action sequence can also form the entire cooking process. If the interpretation to identify the ingredient is performed on the basis of the action sequence, the action sequence can represent a sequence pattern which can be found, for example in the reference database, in an identical or similar manner. The ingredient can then be inferred from the action sequence via the reference database. Thus, the sequence of action can also lead to the ingredient being recognized, especially indirectly. The temporal position of the action sequence in the cooking process can also be a characteristic of the action sequence used to search the reference database. Preferably, the manual user interaction and/or at least one operating parameter can be stored in correlation for the assignment of the action sequence. This means that past user interactions can be used for pattern recognition.

The invention may also provide for several sequences of actions to be stored and to form a recipe, in particular a recipe that can be edited manually by a user at a later date. Thus, for example, several user interactions can lead to an action sequence, whereby several action sequences can lead to a recipe. The recipe can, for example, include the action sequences preparing onions, preparing tomatoes, cooking meat and/or the like. The recipe can be automatically assigned to a name, whereby, for example, the action sequences can lead in a similar way to the recognition of the recipe on the basis of known preparation types. Thus, the cooking process can be easily mapped in a recipe by recording several sequences of actions one after the other by the user, whereby the corresponding ingredients can be identified. It may then be provided that the recipe and/or the action sequences are shown to the user, for example on a display of the kitchen appliance, a computer screen or the like, so that the user can edit the action sequences and/or the recipe. A fine correction can be provided, for example, by changing weight specifications if the user has not adhered exactly to his own specifications when processing the recipe manually. In addition, it is conceivable that the recipe can be assigned meta-properties such as name, occasion or the like by subsequent manual processing. It is also possible to add photos, personal comments or the like. In this way, the recipe can be further individualized and thus enhanced, especially independently of the manual cooking process.

It is also conceivable that, in the case of an inventive method, the method comprises the following step:
Sending the recipe and/or the action sequence to a mobile terminal and/or a server, in particular the recipe and/or the action sequence being prepared on the server.

Preferably, the preparation of the recipe and/or the sending of the recipe can be performed before it is made available for use by other users. By sending the recipe and/or the action sequence, the respective data can be made available to the user in a convenient manner so that the user can edit, share or save the data for themselves. If the recipe is to be sent to a server, the user can make it available to an online community, for example. In particular, training of the reference database can be supported by sending the recipe and/or the action sequence, so that future ingredients and/or action sequences can be recognized more quickly and/or more reliably. The mobile device can preferably include a smartphone, tablet or the like, so that the data can be made directly available to the user in person.

Preferably, in the case of a method according to the invention, the process may include the following step:
Display of the recognized ingredient and/or the action sequence on a display unit of the kitchen appliance, in particular wherein confirmation of the recognized ingredient by the user is expected.

This allows the user to visually check the ingredient and/or the action sequence in order to make corrections if necessary. Thus, the user can be sure that the ingredient and/or action sequence has been correctly recognized. Confirmation by the user is, in particular, a validation so that error detections can be corrected or not transferred to a database. In addition or alternatively, it is conceivable that at least one operating parameter and/or the entire recipe is displayed. By displaying the operating parameter, the user can see another detail of the cooking process so that he can optimize his own cooking behavior and/or recognize error detections. Overall, the interactivity with the user can be further improved by the display, so that the user is involved in the recognition of the cooking process or the ingredient and can intervene at any time.

The invention may also require the user to confirm the addition of the ingredient before entering at least one operating parameter. This can be done, for example, by pressing a key on a user interface. This can ensure, for example, that the user has added the desired amount of the ingredient to the kitchen appliance and/or that a weighing process is completed. In addition, by confirming the addition of the ingredient, the cooking process can be easily divided into a further section, so that, for example, before weighing in the next ingredient, it is made clear that two different ingredients follow each other, so that their measured weight does not lead to a false detection.

Preferably, the method according to the invention, the method may include the following step:
Validate the ingredient, the action sequence and/or the recipe, in particular so that a critical action sequence can be identified.

Validation may include, for example, confirmation by the user. Validation can also be performed automatically and include an external audit. In particular, validation can also be performed by the fact that the same cooking process is performed several times by one user or by several users. This ensures that on the one hand such cooking processes do not end up in a database, the results of which are inedible or which may lead to damage to the kitchen appliance. Furthermore, an average value can be calculated for the setting of target parameters, for example, so that minor deviations during manual user interaction can be compensated for. Thus a quality assurance of the recorded user interactions, action sequences and/or recipes can be accomplished by the validation. The critical action sequence can be understood as an action sequence, which can in particular be part of the recipe, that does not fulfill a certain quality measure.

In the case of an inventive method, it may also be provided that the validation includes at least one of the following steps:
Locating the ingredient in a validation database, in particular by finding a text element in the validation database,
Comparing the at least one operating parameter and/or the manual user interaction with a validation data set, in particular wherein the validation data set is generated by a big data analysis.

The validation database may preferably list critical and/or non-critical ingredients. Preferably, both critical and non-critical ingredients can be listed, with each ingredient provided with metadata that classifies the ingredient as critical or non-critical. Furthermore, at least one operating parameter can be compared with a validation dataset. The validation dataset shall preferably contain validation parameters and/or validation interactions indicating whether the at least one operational parameter and/or the manual user interaction is to be assessed as critical. This enables, for example, to check whether a particular operating parameter is harmful to the ingredient and/or to the sequence of actions. For example, it is conceivable that meat may burn at a certain temperature and thus the validation data set includes a limit value up to which the meat can be heated without suffering any particular loss of quality. Validation may in particular be performed by Big Data analysis, preferably including existing recipes and/or action sequences in the Big Data analysis in order to identify critical or non-critical ingredients or action sequences. In particular, neural networks can be integrated in Big Data analysis. This means that artificial intelligence can be used to improve the digitalization of the cooking process, particularly in order to increase the quality of the results.

It may also be provided that, in the case of an inventive method, the method includes the following step:
Output of a suggestion for improvement depending on data from the reference database and/or the validation database.

The improvement suggestion can, for example, be used to optimize the action sequence on the basis of known action sequences. For example, it is conceivable that the reference database and/or the validation database may indicate that it is advantageous to use a certain quantity of spice when a certain quantity of meat is foreseen. If the user uses less spice, the improvement suggestion may include the use of more spice. Thus, a recipe known to the user can be improved with the help of the reference database and/or the validation database, especially with regard to mass suitability.

According to another aspect of the invention, a kitchen appliance is required to perform a cooking process. The kitchen appliance has a cooking vessel for receiving ingredients and a processing device for processing the ingredients. The kitchen appliance also includes a user interface for manual user interaction. Furthermore, a sensor device is provided for detecting at least one operating parameter during the cooking process. The user interface is connected to an integrated control unit through which a method according to the invention can be initiated, preferably performed.

The processing device for processing the ingredients preferably comprises an agitator for mixing and/or processing the ingredients. The processing device can also have a heating element for heating the ingredients, for example. The user interface may preferably include a rotary knob and/or a display, in particular a touch display. This allows the user to perform the manual user interaction and, for example, select a specific heating temperature or the like. The sensor device can be used to record at least one operating parameter during the cooking process, e.g. a time course of the operating parameter can be recorded. By connecting the user interface to the integrated controller, the kitchen appliance can be used to perform a method as described above. The user can trigger the method via the user interface and the integrated control unit. The initiation of the method can be understood to mean that the user can start the method via the kitchen appliance, while the method can run at least partially on a server which can be connected to the kitchen appliance via data communication. However, it is also conceivable that the method could be produced entirely on the kitchen appliance, in particular by the integrated control unit. This allows the user, for example, to fully access the function of the digitalization of the cooking process when purchasing the kitchen appliance. Furthermore, for example, the recipe can remain on the kitchen appliance, so that there is no need to exchange it with external databases or the like. In particular, the reference database and/or the validation database can be provided via additional modules. Thus, a kitchen appliance in accordance with the invention has the same advantages as those already described in detail in relation to a method according to the invention.

According to another aspect of the invention, a system for the digitalization of a cooking process is required. The system has a kitchen appliance, in particular a kitchen appliance in accordance with the invention, for carrying out the cooking process. The kitchen appliance has a cooking vessel for receiving ingredients and a processing device for processing the ingredients. In addition, the kitchen appliance includes a user interface for manual user interaction. The system further comprises a sensor device for detecting at least one operating parameter during the cooking process. Furthermore, a computing unit is provided through which an ingredient can be identified by interpreting at least the operating parameter and the manual user interaction.

Thus, a system in conformity with the invention has the same advantages as those already described in detail with regard to a method and/or appliance in conformity with the invention. Preferably a method according to the invention can be performed by the server.

The sensor device may in particular be part of the kitchen appliance or form a separate unit. For example, it is conceivable that the sensor device might include an additional camera that is placed near the kitchen appliance to monitor the cooking process. The computing unit can be part of an integrated control unit of the kitchen appliance or part of a server. In particular, a server and the integrated control unit of the kitchen appliance can be in communication connection and thus together form the computing unit. Thus, a system according to the invention can use computing capacities in different ways depending on the requirement profile. By using a server, a central location can be defined where the computing capacity is provided, so that the integrated control unit of the kitchen appliance has only a small computing capacity. This means that the integrated control unit can be correspondingly small and thus allow more design freedom for the kitchen appliance. In addition, the computing unit can be embedded in a network, especially a neural network, which favors the interpretation of at least one operating parameter.

In the context of the invention, it is conceivable that a reference database can be accessed by the server and a comparison of the at least one operating parameter and/or the manual user interaction with the reference database can be performed in order to interpret at least the operating parameter and/or the manual user interaction. The reference database can, for example, be stored in a memory unit of the kitchen appliance or the server, so that the reference database can be accessed directly by the computing unit. Furthermore, the reference database can be decentralized and stored on another server or on several servers. In particular, the reference database may include entries on different correlations of ingredients, operating parameters and user interactions. This enables interpretation of the operating parameter and the user interaction in a simple way, in particular by means of a big data analysis.

The invention may also provide that the computing unit is in communication with a memory unit so that the manual user interaction and/or at least one operating parameter can be stored in the memory unit in correlation to the identified ingredient. The storage unit can be part of the kitchen appliance, part of a server or part of a mobile storage unit, such as a USB stick, a mobile terminal or the like. Thus it is conceivable that one action sequence, several action sequences and/or a recipe are recorded. In addition, the storage unit can provide a database of individual recipes from one or more users, so that they are available in a central location.

It is also conceivable that, in the case of asystem, accoarding to the invention, manual user interaction can be assigned to an action sequence of the cooking process by the server. Thus a part of a recipe or a complete recipe can be formed by the action sequence. In particular, the calculation unit may be configured for this purpose. To interpret the at least one operating parameter and the manual user interaction based on the action sequence. Known action sequences can be compared with the current action sequence to identify the ingredient or find similar or identical action sequences and assign their ingredient to the current ingredient.

Preferably, in a system conforming to the invention, it can be provided that the sensor device has at least one of the following sensors for detecting the at least one operating parameter:
Scale, in particular with three load cells,
Current sensor,
Temperature sensor,
Camera.

The scale can preferably be a three-point scale with which the weight distribution can be determined. Thus, for example, when the ingredient is added to the cooking vessel and, in particular, when the ingredient is mixed through the processing device, the movement behavior of the ingredient can be analysed. This in turn can be a characteristic to infer the ingredient. The current sensor may preferably include an ammeter, voltmeter and/or the like. This enables the current sensor to determine a quantity of energy which is fed to the processing device. Furthermore, it is conceivable that the current sensor is a motor current sensor of an agitator. Thus, an ingredient resistance can be detected via the required motor current during shredding and/or mixing of the ingredient, and thus the ingredient can be identified, especially in connection with the weight of the ingredient. The temperature sensor may be configured to measure the temperature of the ingredient and/or processing device and/or cooking vessel. In particular, a temperature change can be detected by the temperature sensor. The camera can preferably record images, the information from which can be used to deduce the ingredient. Furthermore, it is conceivable in particular that the sensor device has a rotation angle meter, for example of an agitator of the processing device. In addition, it is conceivable that the sensor device may have an RFID sensor. This allows ingredients to be detected, e.g. when filling the cooking vessel, if the packaging of the ingredients is held above the cooking vessel by the user when filling the ingredients.

Preferably, in the case of a system according to the invention, the sensor device may comprise a timepiece by means of which a course of time of at least one operating parameter can be established. The timepiece may therefore include a watch, in particular a stopwatch, or the like. Additionally or alternatively, the server can be equipped with a stopwatch. Due to the temporal course an improved accuracy in the determination of at least one operating parameter can be achieved or further information can be mapped into the operating parameter by the additional dimension of time. This may improve the overall accuracy of ingredient detection.

It is also conceivable that, in a system according to the invention, a server has the computing unit and the kitchen appliance can be brought into communication with the server via a data interface. The data interface may preferably comprise a network connection, in particular a WLAN interface, a LAN interface, a mobile radio interface or the like. This makes it easy to provide a central processing unit which is not fully integrated into the kitchen appliance.

Preferably a display unit is provided with a system according to invention, by which the operating parameter and/or the recognized ingredient can be displayed to a user. In particular, the display unit may include a touch display so that user interaction to change and/or confirm the ingredient and/or operating parameter can be detected. This allows the user to be further involved in the digitalization of the cooking process so that he can intervene at any time. In addition, error detections can be reduced and the display unit can be used for validation purposes.

Advantageously, in the case of an inventive system, the computing unit can be configured to find the ingredient in a validation database and/or to compare at least one operating parameter and/or the manual user interaction with a validation data record, which is in particular generated by a Big Data analysis, in order to perform a validation. Validation can provide a quality measure that ensures that the recorded sequences of actions by the user meet a specified quality before the data is made available to a database, the user, or other users.

Further advantages, features and details of the invention result from the following description, in which examples of the execution of the invention are described in detail with reference to the drawings. The features mentioned in the claims and in the description may be essential to the invention either individually or in any combination. It is shown:

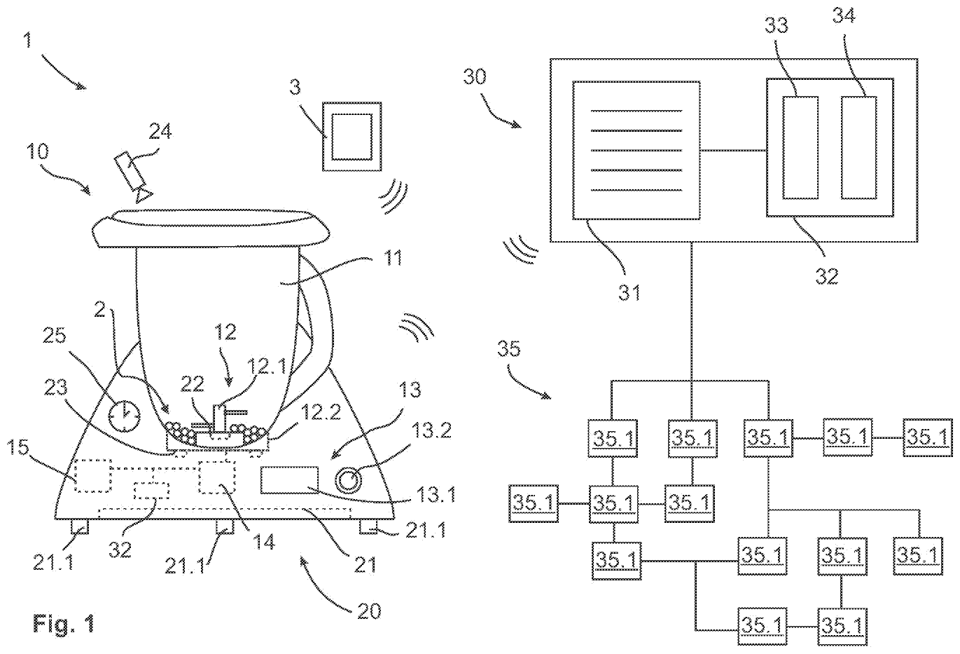

FIG. 1 shows a system according to the invention with a kitchen appliance according to the invention in a schematic representation in a first embodiment,

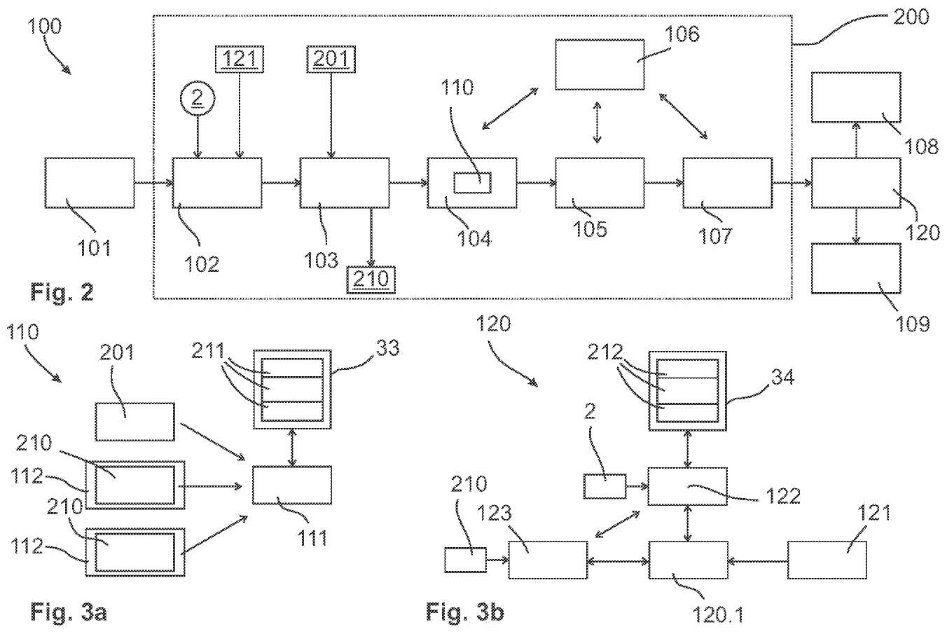

FIG. 2 a method according to the invention in a schematic representation of the procedural steps in a second embodiment,

FIG. 3a-b a more detailed description of the procedural steps of the method according to the invention of the second embodiment,

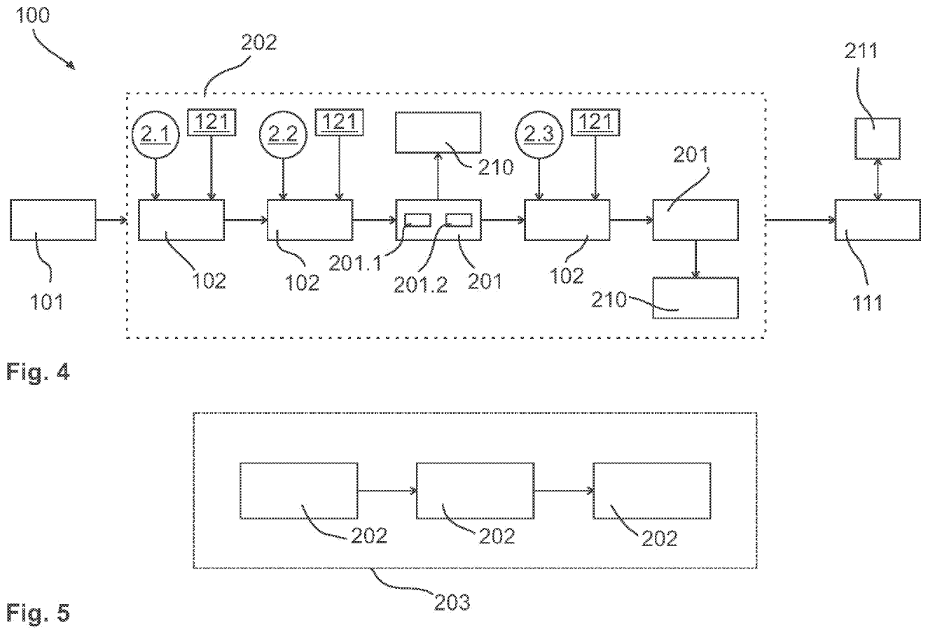

FIG. 4 a method according to the invention in a schematic representation in a third ambodiment,

FIG. 5 a recipe according to the invention of the third embodiment.

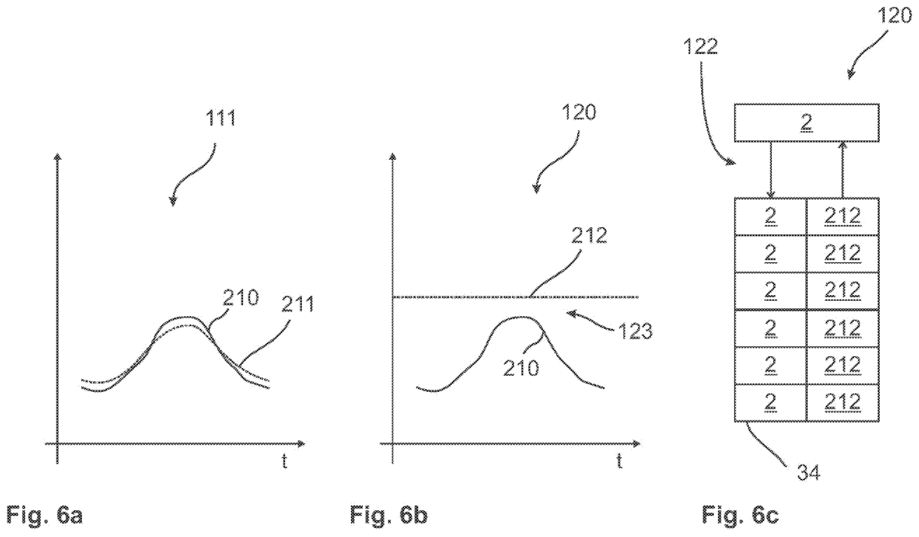

FIGS. 6a-c Data comparisons for an inventive method in further embodiments,

In the following figures, the identical reference signs are used for the same technical characteristics, even for different embodments.

FIG. 1 shows an invention-compliant system 1 for the digitalization of a cooking process 200. The invention-compliant kitchen appliance 10 is provided, which is suitable for peformed the cooking process 200 with a cooking vessel 11. The cooking vessel 11 is configured to hold ingredients 2, so that they can be added to the cooking vessel 11 via a lid, for example.

Furthermore, the kitchen appliance 10 has a processing device 12 for processing the ingredients 2. The processing device 12 comprises an agitator 12.1 for mixing and/or crushing the ingredients 2. In addition, the processing device 12 has a heating element 12.2 which is configured to heat the ingredients 2. Preferably the heating element 12.2 is an electric heating element and the agitator 12.1 is an electrically driven agitator. Furthermore, the kitchen appliance 10 includes a user interface 13 for starting a manual user interaction 201. The user interface 13 includes a display unit 13.1 and a rotary knob 13.2. The user interface 13 allows the user to conveniently operate the kitchen appliance 10. In addition, the kitchen appliance 10 has a sensor device 20 for detecting 103 at least one operating parameter 210 during the cooking process 200. In the example shown, the sensor device 20 is part of the kitchen appliance 10. However, it is also conceivable that the sensor device 20 is attached to the kitchen appliance 10 as an additional module or is provided as an independent unit beside the kitchen appliance 10. Furthermore, the kitchen appliance 10 has an integrated control unit 14, which is connected to an internal memory unit 32 of the kitchen appliance 10. In the internal memory unit 32, for example, the operating parameters and the manual user interaction can be stored. Furthermore, the control unit 14 can be connected to a computing unit 31 via a data interface 15. This enables to start processes on the computing unit 31 in which the user operates the user interface 13 of the kitchen appliance 10, whose signal is processed accordingly by the integrated control unit 14 and, if necessary, triggers communication with the computing unit 31. The computing unit 31 is configured to identify an ingredient 2 by interpretation 110 of at least one operating parameter 210 and manual user input 201. The operating parameter 210 is preferably a measured value which is recorded in the kitchen appliance 10, especially during the cooking process 200. For this purpose, the sensor device 20 includes a scale 21 to record the weight of the added ingredient 2. In particular, the scale 21 comprises three load cells 21.1, which are configured as a stand for the kitchen appliance. This means that a weight distribution within the cooking vessel 11 can also be recorded by the scale 21 in order to determine ingredient 2. For example, it is conceivable that a certain flow and/or pouring behaviour of the ingredient 2 at a certain speed of the agitator 12.1 is characteristic of the ingredient 2 to be identified. In particular, the agitator 12.1 can be equipped with a tachometer for this purpose. Furthermore, it is conceivable that the sensor device 20 has a current sensor 22 through which the motor current of the agitator 12.1 can be detected. A higher motor current at a given speed can therefore indicate a higher resistance due to ingredient 2. In addition, a temperature sensor 23 is provided to measure the temperature of ingredient 2 and/or in cooking vessel 11. Temperature sensor 23 can therefore also be used to determine a further characteristic, namely, for example, the heating behaviour, in particular the specific heat capacity, ingredient 2. Furthermore, a camera 24 is provided in order to visually record ingredient 2 and, for example, to be able to infer ingredient 2 from a change in the colour of ingredient 2 during a heating process. The sensor device 20 further comprises a timepiece 25, by means of which a progression of time of the at least one operating parameter 210 can be recorded. Thus, the timepiece 25, which can include in particular a watch, can give a temporal dimension to the operating parameter 210, thus allowing a higher reliability in the identification 104 of the ingredient 2. In this example, the identification 104 or interpretation 110 of the operating parameter 210 and the manual user interaction 201 is performed by a server 30 that has the computing unit 31. In order to be able to perform a comparison of the data with known reference and/or validation data, the server 30 also has a storage unit 32 with a reference database 33 and a validation database 34. In addition, the server 30 is part of or connected to a network 35, in particular a neural network. Over network 35, which has a plurality of network nodes 35.1, it is possible to perform a big data analysis, the network nodes 35.1 comprising databases with known characteristics of ingredients in large numbers, which can be analyzed and made available to the server 30. This enables the computing unit 31, in particular by accessing the network 35, to perform the interpretation 110 of at least one operating parameter 210 and thus to conclude on the ingredient 2. In order to display the data to the user in intermediate steps and/or as a result, the data can also be sent to a mobile terminal 3, i.e. in particular a smartphone, tablet or the like, which can communicate with the kitchen appliance 10 and/or the server 30.

FIG. 2 shows a method 100 for the digitalization of a cooking process 200 for a kitchen appliance 10. This preferably requires the user to start 101cooking process 200 first. The user thereby confirms that a cooking process 200 is being performed, which is at least partially performed manually. The kitchen appliance 10 also recognises that certain sections of the following process or actions are to be recorded. Thereupon, an intake 102 of an ingredient 2 is provided by a cooking vessel 11 of the kitchen appliance 10. If the user has completely filled in ingredient 2, a confirmation 121 is required by which the user informs the kitchen appliance 10 that ingredient 2 is completely filled in. With the confirmation 121 or after the confirmation 121 a manual user interaction 201 takes place, which triggers a certain behaviour of the kitchen appliance 10. For example, the user starts an agitator 12.1 of the kitchen appliance 10 at a certain speed or starts the heating process of a heating element 12.2. In particular, after detecting 103 at least one operating parameter 210 as a result of the manual user interaction 201, the ingredient 2 is identified 104 by interpreting 110 the at least one operating parameter 210 and the at least one manual user interaction 201.

FIG. 3a shows the interpretation of 110 in a schematic, exemplary representation. In this case, there is a storage 112 of at least one operating parameter 210 during a cooking step of the cooking process 200, which was triggered by a manual user interaction 201. Preferably, several operating parameters 210 are recorded and stored simultaneously, so that the most comprehensive possible picture of the characteristic behaviour of ingredient 2 is available. In connection with the manual user interaction 201 performed, a comparison 111 is finally performed, for which reference data records 211 of a reference database 33, for example, are used. Reference records 211 may include library data of known ingredients that reflect their characteristic behaviour in the user interaction performed. For example, it is conceivable that onions generate a characteristic motor current curve when they are comminuted at a specified speed in the agitator 12.1 of the kitchen appliance 10. At the same time, it may be provided that the onions are to be heated and that their heating curve is also recorded, thus indicating the specific heat capacity of ingredient 2. If a similar material behaviour is now found in the reference data sets 211, it is highly probable that onions can be concluded. In particular, the reference database 33 may be supplemented with or based on data from a big data analysis.

After identifying 104, an assignment 105 of the ingredient 2 and/or the manual user interaction 201 to an action sequence 202 preferably takes place. The action sequence 202 can preferably comprise a part of a recipe 203, so that an assignment 107 of the action sequence 202 to a recipe 203 subsequently takes place. This means that recipe 203 can preferably be digitalized step by step. Furthermore, after or during identification 104 the ingredient 2, the assignment 105 to an action sequence 202 and the assignment 107 to recipe 203 can be displayed 106 to the user, so that the user is informed at any time during the cooking process about the current status of the data acquisition. In addition, depending on the display 106, a confirmation 121 may be provided by the user before the next procedural step takes place. This ensures that errors are detected early in the process and can be corrected manually or automatically. After assigning 107 to the recipe 203, a sending 108 of the recipe 203 and/or the action sequence 202 to a mobile terminal 3 and/or a server 30 is also provided. The mobile terminal device 3 can, for example, be a smartphone or tablet of the user, so that he has the recipe 203 and/or action sequence 202 digitally available. The recipe 203 and/or the action sequence 202 can, for example, be made available to an online community via a server 30. Preferably before or after sending 108 the corresponding data to server 30 or mobile device 3, validation 120 is provided.

FIG. 3b shows a schematic representation of validation 120. A comparison 123 of the recorded operating parameter 210 with a validation data set 212 is provided. Preferably, validation record 212 is generated by a big data analysis and/or retrieved from a validation database 34. For this purpose, a finding 122 of the ingredient 2 in a validation database 34 is provided, whereby a text element of the ingredient 2 is generated and a finding of the text element can take place in the validation database 34. It is also conceivable that finding 122 the ingredient 2 in the validation database 34 on the basis of validation record 212 itself represents a validation result 120.1. In addition or alternatively, validation 120 may include a confirmation 121 from a user. Validating 120 ensures that the recorded cooking process meets 200 specific quality criteria. In particular, this can ensure that only recipes 203 with harmless ingredients 2 are made available, for example, in an online community. Furthermore, on the basis of validation 120, an output of an improvement suggestion can be made, in which certain action sequences 202 are improved. This can be based, for example, on an average perception of food quality. Preferably, confirmation 121 by the user, finding of 122 of ingredient 2 in validation database 34 and/or comparison 123 may lead to validation result 120.1, which classifies ingredient 2, action sequence 202 and/or recipe 203 as critical or non-critical.

In particular, based on the validation result 120.1, it is also possible to output 109 of an improvement suggestion before or after sending 108 of the data to server 30. The improvement suggestion can include, for example, adaptations of recipe 304 to a quality specification or the like.

FIG. 4 also shows a method100 in another example. The starting 101 of a digitalization of a cooking process 200 is planned. First an action sequence 202 comprising several ingredients 2.1, 2.2, 2.3 and several manual user interactions 201 is recorded and finally interpreted. For example, it is planned to first record 102 of a first ingredient 2.1 in a cooking vessel 11 of a kitchen appliance 10. The first ingredient 2.1 is followed by the addition 102 of a second ingredient 2.2 Preferably, confirmation 121 is required after the addition of each of the ingredients 2.1, 2.1 by the user, so that it is clear for the interpretation of the data that two different ingredients 2.1, 2.2 have been added. Finally, each ingredient 2.1, 2.2 can be assigned an operating parameter of 210, i.e. in particular a weight, via a scale 21 of the kitchen appliance 10. This is followed by a manual user interaction 201, which starts or carries out, for example, comminution and mixing of the existing ingredients 2.1, 2.2. In particular, a manual user interaction 201 can include several manual, preferably different, partial interactions 201.1, 201.2, which in turn represent partial sequences. During comminution, at least one operating parameter 210 is recorded, which can be assigned to user interaction 201. Afterwards, 102 is added to a third ingredient 2.3, which is followed by another manual user interaction 201. The manual user interaction 201 can include a renewed comminution of the total mass now present in the cooking vessel 11 and/or heating. For example, the first ingredient may include 2.1 onions and the second ingredient 2.2 cloves of garlic. These are first crushed and steamed before the third ingredient 2.3 tomatoes are added, which are crushed and heated again, while onions and garlic cloves are still present in the cooking vessel 11. This also results in the recording of at least one further operating parameter 210, which can be assigned to manual user interaction 201. Thus, the entire action sequence 202 with different inputs and system reactions is initially available. The sequence of actions, i.e. in particular the sequence of actions in combination with the recorded operating parameters 210, can thus lead to an adjustment 111, via which such standardized sequences of actions can be found via a reference database 33. In this way, known partial steps of a recipe 203 can also be identified as a whole and, accordingly, the ingredients involved 2.1, 2.2, 2.3.

According to FIG. 5, several action sequences 202 finally result in a recipe 203, which was at least partially performed manually by the user during the cooking process 200 and is then available in digital form.

FIG. 6a schematically shows a course of time of an operating parameter 210, which is compared with a reference data set 211, which is also present as a temporal course, in order to compare 111 of the data. If the operating parameters 210 and the reference data set 211 deviate from each other within a certain tolerance, the presence of a certain ingredient 2 whose characteristic is mapped by the reference data set 211 over time can be concluded with high probability.

FIG. 6b schematically shows the temporal course of the operating parameter 210, which for validating 120 is compared with a validation data set 212, which comprises a limit value, in a comparison 123. If the operating parameter 210 does not exceed the limit value of the validation data set 212 within the recorded time course, the section of the cooking process 200 assigned to the operating parameter 210 can be classified as non-critical.

FIG. 6c shows another possibility of validating 120 in another example. An ingredient 2 itself is validated, whereby the ingredient 2 is searched in a validation database 34 with entries for different ingredients 2. In validation database 34, each ingredient 2 is also assigned a validation data record 212, which classifies the respective ingredient 2 as critical or non-critical. If a finding 122 of the ingredient 2 to be validated in the validation database 34 is successful, the associated validation data record 212 is output, in particular as validation result 120.1, so that a classification can be displayed to the user, for example.

The preceding explanation of the embodiements describes the present invention exclusively in the context of examples. Of course, individual features of the embodiments can be freely combined with each other, if technically reasonable, without leaving the scope of the present invention.

### REFERENCE CHARACTER LIST

1 System

2 Ingredients

2.1 First ingredient

2.2 Second ingredient

2.3 Third ingredient

3 mobile device

10 Kitchen appliance

11 Cooking vessel

12 Processing device

12.1 Agitator

12.2 Heating element

13 User interface

13.1 Display unit

13.2 Rotary knob

14 Control unit

15 Data Interface

20 Sensor device

21 Scale

21.1 Load cell

22 Current sensor

23 Temperature sensor

24 Camera

25 Timer

30 Server

31 Computing unit

32 Memory unit

33 Reference database

34 Validation database

35 Network

35.1 Network node

100 Methods

101 Start

102 Receiving of 2

103 Detection of 210

104 Identifying of 2

105 Assigned to 202

106 Display

107 Assigned to 203

108 Send to 203

109 Output of a suggestion for improvement

110 Interpreting of 201 and 210

111 Adjustment

112 Save

120 Validate

120.1 Result of validation

121 Confirmation

122 Location of 2

123 Compare

200 Cooking process

201 Manual user interaction

201.1 Partial interaction

201.2 Partial interaction

202 Action sequence

203 Recipe

210 Operating parameters

211 Reference dataset

212 Validation data record

1-22. (canceled)

23. A method for the digitalization of a cooking process in a kitchen appliance comprising the following steps:
detection of at least one operating parameter of the kitchen appliance during a manual user interaction for processing an ingredient stored in the kitchen appliance,
identifying the ingredient by interpreting at least the operating parameter and the manual user interaction.

24. The method according to claim 23, wherein the detection of the at least one operating parameter comprises recording a time course of the at least one operating parameter.

25. The method according to claim 23, wherein the interpreting for identifying the ingredient comprises at least a comparison of at least the operating parameter or the manual user interaction with a reference database.

26. The method according to claim 23, wherein the manual user interaction is assigned to an action sequence of the cooking process.

27. The method according to claim 23, wherein a plurality of action sequences are stored and form a recipe.

28. The method according to claim 23, wherein the method comprises the following step:
sending at least the recipe or the action sequence to at least a mobile device or a server.

29. The method according to claim 23, wherein the method comprises the following step:
display of at least the recognized ingredient or of the action sequence on a display unit of the kitchen appliance.

30. The method according to claim 23, wherein a containment of an addition of the ingredient by the user is required before the at least one operating parameter is detected.

31. The method according to claim 23, wherein the method comprises the following step:
validating at least the ingredient, the action sequence or the recipe.

32. The method according to claim 23, wherein the validation comprises at least one of the following steps:
locating the ingredient in a validation database,
comparing at least the at least one operating parameter or the manual user interaction with a validation data set.

33. The method according to claim 23, wherein the method comprises the following step:
outlet a suggestion for improvement based on data from at least the reference database or the validation database.

34. A kitchen appliance for performing a cooking process comprising:
a cooking vessel for receiving ingredients,
a processing device for processing the ingredients,
a user interface for manual user interaction, and
a sensor device for detecting at least one operating parameter during the cooking process,
wherein the user interface is connected to an integrated control device by means of which a method can be initiated for the digitalization of a cooking process in a kitchen appliance comprising the steps detection of at least one operating parameter of the kitchen appliance during a manual user interaction for processing an ingredient stored in the kitchen appliance, identifying the ingredient by interpreting at least the operating parameter and the manual user interaction.

35. A system for the digitalization of a cooking process comprising:
a kitchen appliance for carrying out the cooking process, having a cooking vessel for receiving ingredients and a processing device for processing the ingredients, a user interface for a manual user interaction, and
a sensor device for detecting at least one operating parameter during the cooking process, wherein a computing unit is provided by means of which an ingredient can be identified by interpretation of at least the operating parameter and the manual user interaction.

36. The system according to claim 35, wherein a reference database can be accessed by the computing unit and, in order to interpret at least the operating parameter or the manual user interaction, a comparison can be carried out at least between the at least one operating parameter or the manual user interaction and the reference database.

37. The system according to claim 35, wherein the computing unit is in communication connection with a memory unit so that at least the manual user interaction or the at least one operating parameter can be stored in the memory unit in correlation with the recognized ingredient.

38. The system according to claim 35, wherein the manual user interaction can be assigned to at least one action sequence of the cooking process by the computing unit.

39. The system according to claim 35, wherein the sensor device has at least one of the following sensors for detecting the at least one operating parameter:
scale,
current sensor,
temperature sensor,
camera.

40. The system according to claim 35, wherein at least the sensor device comprises a chronometer, by means of which a temporal progression of the at least one operating parameter can be established, or wherein a server comprising the computing unit and the kitchen appliance can be brought into communication connection with the server via a data interface.

41. The system according to claim 35, wherein a display unit is provided, by means of which at least the operating parameter or the recognized ingredient can be displayed to a user.

42. The system according to claim 35, wherein at least the computing unit is configured to find the ingredient in a validation database at least for carrying out a validation or to compare the at least one operating parameter or the manual user interaction with a validation data record, or wherein a method for the digitalization of a cooking process in a kitchen appliance comprising the steps detection of at least one operating parameter of the kitchen appliance during a manual user interaction for processing an ingredient stored in the kitchen appliance, identifying the ingredient by interpreting at least the operating parameter and the manual user interaction can be performed by the server.
